(19) United States
(12) Patent Application Publication
(10) Pub. No.: US 2023/0057645 A1
(43) Pub. Date: Feb. 23, 2023

(54) HEATING ASSEMBLY, ATOMIZER AND ELECTRONIC ATOMIZATION DEVICE

(71) Applicant: SHENZHEN SMOORE TECHNOLOGY LIMITED, Shenzhen (CN)

(72) Inventors: Zhenlong JIANG, Shenzhen (CN); Hongxia LV, Shenzhen (CN); Pei LI, Shenzhen (CN)

(21) Appl. No.: 18/046,086

(22) Filed: Oct. 12, 2022

Related U.S. Application Data
(63) Continuation of application No. PCT/CN2020/086971, filed on Apr. 26, 2020.

(51) Int. Cl. A24F 40/46; A24F 40/10; A24F 40/44; A24F 40/42; H05B 6/10

(52) U.S. Cl. CPC A24F 40/46; A24F 40/10; A24F 40/44; A24F 40/42; H05B 6/108

(57) ABSTRACT

A heating assembly includes: a preheating portion; and a vaporization portion located on the preheating portion. The preheating portion includes a porous ceramic and a positive temperature coefficient thermosensitive material. A circuit in which the preheating portion is located is connected in parallel with a circuit in which the vaporization portion is located.

### CROSS-REFERENCE TO PRIOR APPLICATION

This application is a continuation of International Patent Application No. PCT/CN2020/086971, filed on Apr. 26, 2020. The entire disclosure is hereby incorporated by reference herein.

### FIELD

The present invention relates to the technical field of electronic cigarettes, and in particular, to a heating assembly, a vaporizer, and an electronic vaporization device.

### BACKGROUND

An electronic cigarette generally includes an e-liquid storage cavity used for storing e-liquid, a vaporizer configured to vaporize the e-liquid, and a battery component configured to supply power to the vaporizer. The vaporizer includes a heating body, and the e-liquid in the e-liquid storage cavity is penetrated or guided to the heating body to be vaporized. The vaporizer serves as a core device of the electronic cigarette to generate vaporized gas, and a vaporization effect of the vaporizer determines the quality and taste of vapor.

At present, the electronic cigarette has a relatively high requirement on the concentration of the e-liquid, but e-liquid with higher concentration also has higher viscosity and poorer penetrability or flowability, and is less likely to be penetrated or guided from the e-liquid storage cavity to the heating body. Therefore, the e-liquid may be less vaporized due to insufficient e-liquid supply. In addition, the current e-liquid is easily affected by a low temperature. Under a low temperature condition, the e-liquid is less likely to be penetrated or guided to the heating body. Therefore, the current electronic cigarette is often prone to less vapor or no vapor each time first inhalation is taken, resulting in poor user experience.

### SUMMARY

In an embodiment, the present invention provides a heating assembly, comprising: a preheating portion; and a vaporization portion located on the preheating portion, wherein the preheating portion comprises a porous ceramic and a positive temperature coefficient thermosensitive material, and wherein a circuit in which the preheating portion is located is connected in parallel with a circuit in which the vaporization portion is located.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a cross-sectional view of an electronic vaporization device according to an implementation;

FIG. 2 is a partial view of a heating assembly of the electronic vaporization device shown in FIG. 1;

FIG. 3 is a circuit diagram of a heating assembly at an initial stage and a later stage of electrification according to an implementation;

FIG. 4 is a circuit diagram of a heating assembly at an initial stage and a later stage of electrification according to another implementation;

FIG. 5 is a cross-sectional view of an electronic vaporization device according to another implementation; and

FIG. 6 is a partial view of a heating assembly of the electronic vaporization device according to the implementation shown in FIG. 5.

### DETAILED DESCRIPTION

In an embodiment, the present invention provides a heating assembly capable of preheating e-liquid to cope with the problem of less vapor or no vapor that easily occurs at the beginning of inhalation.

The heating assembly includes a preheating portion and a vaporization portion located on the preheating portion. The preheating portion is made of a porous ceramic, the preheating portion is made of a positive temperature coefficient thermosensitive material, and a circuit in which the preheating portion is located is connected in parallel with a circuit in which the vaporization portion is located.

In addition, an electronic vaporization device and a vaporizer including the foregoing heating assembly capable of preheating e-liquid are provided.

The vaporizer includes:

a liquid storage container, including a liquid storage cavity used for storing liquid to be vaporized, where the liquid storage cavity is provided with a liquid outlet; and

a heating assembly, configured to vaporize the liquid to be vaporized, where the heating assembly is the foregoing heating assembly, and the preheating portion is close to the liquid outlet.

The electronic vaporization device includes:

a vaporizer, where the vaporizer includes:

a liquid storage container, including a liquid storage cavity used for storing liquid to be vaporized, where the liquid storage cavity is provided with a liquid outlet;

a heating assembly, configured to vaporize the liquid to be vaporized, where the heating assembly is the foregoing heating assembly, and the preheating portion is close to the liquid outlet; and

a power supply, configured to supply power to the vaporizer.

To help understand the present invention, the following describes the present invention more fully with reference to the related accompanying drawings. The accompanying drawings show some embodiments of the present invention. However, the present invention may be implemented in many different forms, and is not limited to the embodiments described in this specification. On the contrary, the embodiments are provided to make the disclosed content of the present invention clearer and more comprehensive.

It should be noted that, when a component is referred to as “being fixed to” another component, the component may be directly on the another component, or there may be an intermediate component. When a component is considered to be “connected to” another component, the component may be directly connected to the another component, or an intervening component may also be present. Unless otherwise defined, meanings of all technical and scientific terms used in this specification are the same as that usually understood by a person skilled in the technical field to which the present invention belongs. In this specification, terms used in the specification of the present invention are merely intended to describe objectives of the specific embodiments, but are not intended to limit the present invention. The term “and/or” used in this specification includes any and all combinations of one or more related listed items.

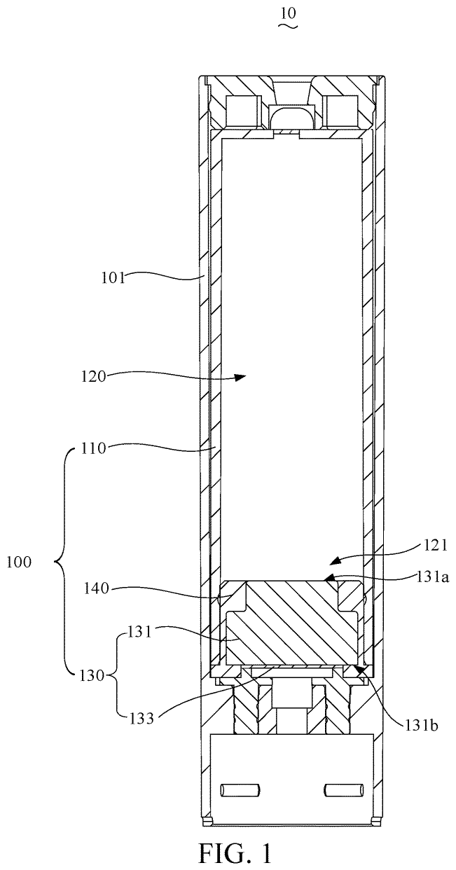

Referring to FIG. 1, an electronic vaporization device 10 according to an implementation is provided. The electronic vaporization device 10 includes a shell 101 and a vaporizer 100. The vaporizer 100 is accommodated in the shell 101, and the vaporizer 100 is configured to vaporize liquid. Certainly, the shape of the shell is not particularly limited, and may be designed according to an actual case, for example, as a column shape, a bar shape, or a square shape. Certainly, it may be understood that in some implementations, the shell 101 may be omitted.

In an embodiment, the electronic vaporization device 10 is an electronic cigarette, and the vaporizer 100 is configured to vaporize e-liquid. Certainly, in other implementations, in addition to the electronic cigarette, the electronic vaporization device 10 may also be another device including the vaporizer 100. The electronic vaporization device 10 can vaporize liquid with relatively high viscosity.

Specifically, the vaporizer 100 includes a liquid storage container 110, a heating assembly 130, a seal member 140, a connection circuit, and a power supply.

Specifically, the liquid storage container 110 includes a liquid storage cavity 120 used for storing liquid (for example, e-liquid) to be vaporized. Certainly, the liquid storage cavity 120 includes a liquid outlet 121. The liquid outlet 121 is used for inflow and/or outflow of the liquid to be vaporized.

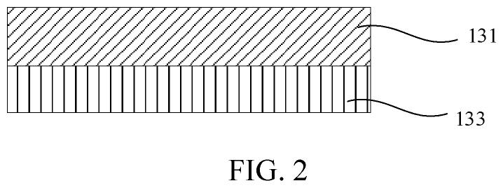

Specifically, the heating assembly 130 is close to the liquid outlet 121. The heating assembly 130 is configured to absorb the liquid to be vaporized in the liquid storage cavity 120, and preheat and vaporize the liquid to be vaporized. Referring to FIG. 2 together, the heating assembly 130 includes a preheating portion 131 and a vaporization portion 133 located on the preheating portion 131. The preheating portion 131 is made of a porous ceramic, and the preheating portion 131 is made of a positive temperature coefficient (PTC) thermosensitive material. Specifically, the preheating portion 131 includes a liquid inlet surface 131a and a liquid outlet surface 131b opposite to the liquid inlet surface 131a. The liquid inlet surface 131a is close to the liquid outlet 121.

The preheating portion 131 is configured to absorb the liquid to be vaporized in the liquid storage cavity 120, and preheat the liquid to be vaporized absorbed from the liquid storage cavity 120, to improve the flowability of the liquid to be vaporized in the preheating portion 131, so that the liquid to be vaporized in the liquid storage cavity 120 can reach the vaporization portion 133 more quickly to be vaporized into vapor for a user to inhale. Specifically, the preheating portion 131 is made of the porous ceramic, and the porous ceramic enables the preheating portion 131 to absorb the liquid to be vaporized in the liquid storage cavity 120, to provide a liquid guide function. In addition, the preheating portion 131 is also made of the positive temperature coefficient thermosensitive material, that is, the preheating portion 131 is a thermistor. A resistance of the preheating portion 131 increases as the temperature increases, so that the preheating portion 131 can use electric energy mainly to preheat the liquid to be vaporized at an initial stage of electrification, and can use the electric energy mainly to vaporize the liquid to be vaporized after the preheating ends. Therefore, the liquid to be vaporized is preheated, and it is avoided that only a small amount of the liquid to be vaporized is vaporized due to the poor flowability of the liquid to be vaporized. In addition, since a preheating circuit is not always in a working state (there is no large amount of current always flowing), when the electric energy is mainly used to vaporize the liquid to be vaporized, the preheating portion 131 preheats the liquid to be vaporized through a residual temperature, thereby further realizing energy saving.

In an embodiment, a Curie temperature of the preheating portion 131 does not exceed 200° C. Further, the Curie temperature of the preheating portion 131 is 100° C. to 200° C. The Curie temperature is a temperature at which a PTC resistance begins to increase steeply. The Curie temperature of the preheating portion 131 is set as above, so that the liquid to be vaporized is rapidly preheated. In addition, the Curie temperature of the preheating portion 131 is set as above, which also controls distribution of the electric energy. By controlling the electric energy on the preheating portion 131, the waste of excessive electric energy on the preheating portion 131 being converted into heat energy is avoided, and the utilization of the electric energy is improved.

In an embodiment, a lift-to-drag ratio of the preheating portion 131 is greater than 1×10². Further, the lift-to-drag ratio of the preheating portion 131 is 1×10² to 1×10⁵. Still further, the lift-to-drag ratio of the preheating portion 131 is 10³- to 10⁵. The lift-to-drag ratio of the preheating portion 131 is set as above, so that a resistance of the preheating portion 131 can be rapidly increased after a temperature range suitable for preheating is reached, The resistance of the preheating portion 131 is rapidly increased, so that the circuit in which the preheating portion 131 is located is turned into an open circuit more quickly, and then the current mainly flows to the circuit in which the vaporization portion 133 is located, to realize a rapid transition between the electric energy mainly being used for preheating and the electric energy mainly being used for vaporization.

In an embodiment, a resistivity of the preheating portion 131 under a normal temperature condition is 0.25 Ω/cm to 28 Ω/cm. Further, the resistivity of the preheating portion 131 under the normal temperature condition is 1 Ω/cm to 20 Ω/cm. The resistivity of the preheating portion 131 is set as above, so that the preheating portion 131 generates heat rapidly to heat the liquid to be vaporized in pores of the preheating portion 131.

In an embodiment, the preheating portion 131 is selected from one of a BaTiO₃-based PTC ceramic with a porous structure, a SrTiO₃-based PTC ceramic with a porous structure, a PbTiO₃-based PTC ceramic with a porous structure, or a V₂O₃-based PTC ceramic with a porous structure.

The PTC ceramic is a semiconductor ceramic formed by sintering and is mainly composed of barium titanate (or strontium titanate and lead titanate), added with additives such as a small amount of rare earth elements (Y, Nb, Bi, and Sb), acceptor (Mn, Fe) elements, and glass (silicon oxide and aluminum oxide). The ceramic PTC has a small resistance below the Curie temperature, and the resistance increases by a step of 1,000 times to a million times above the Curie temperature. In a commonly used doping method, a donor is doped with ions such as La, Y, Nb, and Sb, and an acceptor is doped with 3d group metal elements such as Mn, Cu, and Fe. Through doping, the resistivity of the PTC ceramic under the normal temperature condition is reduced, and the lift-to-drag ratio is increased.

In this implementation, the BaTiO₃-based PTC ceramic with a porous structure is a porous ceramic made of barium titanate as basic material and doped with other polycrystalline ceramic materials. A PTC effect of BaTiO₃ is related to ferroelectricity of BaTiO₃, and the resistivity mutation of BaTiO₃ corresponds to the Curie temperature. However, a BaTiO₃ single crystal without a grain boundary does not have the PTC effect. Only a BaTiO₃ ceramic whose grains are fully semiconducted and whose grain boundary has proper insulation has the PTC effect. During preparation of the BaTiO₃-based PTC ceramic, the grains are fully semiconducted by using donor doping, and the grain boundary and vicinity of the grain boundary are oxidized by sintering under oxygen atmosphere, to provide proper insulation. Slow cooling also makes the grain boundary fully oxidized, and the PTC effect is enhanced.

Specifically, the preheating portion 131 is doped with at least one of La, Y, Nb, or Sb. The rare earth elements are doped, so that impedance of the BaTiO₃-based PTC ceramic under the normal temperature condition is lower, and the lift-to-drag ratio is also increased.

Further, the preheating portion 131 is doped with La, and the doping amount of La is 0.1% to 1%. Doping La may cause the resistivity of the preheating portion 131 to reach 28 Ω/cm, and the lift-to-drag ratio to reach 1×10^{3.7}. Certainly, in another embodiment, in addition to the BaTiO₃-based PTC ceramic with a porous structure, the preheating portion 131 may be another PTC ceramic with a porous structure.

Certainly, the preheating portion 131 is provided with an end electrode, and the end electrode of the preheating portion 131 is electrically connected to the power supply. It may be understood that the shape of the preheating portion 131 is not particularly limited, for example, may be a bar shape, a cylinder shape, or a step shape.

Specifically, the vaporization portion 133 is located between the preheating portion 131 and the liquid outlet 121, and is configured to vaporize the liquid to be vaporized guided by the preheating portion 131. More specifically, the vaporization portion 133 is located on the liquid outlet surface 131b, and the vaporization portion 133 is configured to vaporize the liquid to be vaporized. In a static state, the circuit in which the preheating portion 131 is located and the circuit in which the vaporization portion 133 is located form a parallel circuit. In the illustrated implementation, the vaporization portion 133 is provided on the liquid outlet surface 131b in a contact manner.

In an embodiment, under the normal temperature condition, a ratio of a resistance of the vaporization portion 133 to a resistance of the preheating portion 131 is 1:0.1 to 2. Under the normal temperature condition, the ratio of the resistance of the vaporization portion 133 to the resistance of the preheating portion 131 is 1:0.1 to 1. Further, under the normal temperature condition, the ratio of the resistance of the vaporization portion 133 to the resistance of the preheating portion 131 is 1:0.1 to 0.5. According to the foregoing setting, the electric energy may be mainly used for the preheating portion 131 to generate heat in the initial stage of electrification, to preheat the liquid to be vaporized.

In an embodiment, a material of the vaporization portion 133 is selected from at least one of a single metal, an alloy, an NTC ceramic, a carbon fiber, or graphite. Specifically, the single metal may be selected from metals commonly used in the art for heating, for example, nickel or aluminum. The alloy may be selected from alloys commonly used in the art for heating, for example, a nickel alloy, a silver alloy, or an aluminum alloy.

In an embodiment, the material of the vaporization portion 133 is the NTC ceramic. A resistance of the NTC ceramic gradually decreases as the temperature increases. The vast majority of NTC ceramics are spinel-type oxides, mainly manganese-containing binary and manganese-containing ternary oxides. For example, the manganese-containing binary oxides include MnO—CuO—O₂ oxide, MnO—CoO—O₂ oxide, and MnO—NiO—O₂ oxide, and the manganese-containing ternary oxides include Mn—Co—Ni oxide, Mn—Cu—N oxide, and Mn—Cu—Co-based oxide. A MnO—CoO—O₂ oxide ceramic contains 23% to 60% (mass fraction) manganese, and has a main crystal phase of a cubic spinel MnCo₂O₄ and a tetragonal spinel CoMn₂O₄, and a main conductive phase of MnCo₂O₄. After electrification, the resistance of the vaporization portion 133 is relatively large, and enabling of the vaporization function is relatively delayed, so that the electric energy is mainly concentrated on the preheating portion 131. As the preheating portion 131 generates heat continuously, the liquid to be vaporized is preheated, and, part of the heat is also transferred to the vaporization portion 133 so that the resistance of the vaporization portion 133 is reduced, thereby enabling the vaporization function of the vaporization portion 133. Therefore, when the material of the vaporization portion 133 is the NTC ceramic, the heating assembly 130 can perform preheating and vaporization more quickly.

Specifically, when the material of the vaporization portion 133 is the NTC ceramic, the resistivity of the vaporization portion 133 under the normal temperature condition is 1×10¹ Ω/cm to 1×10⁶ Ω/cm. In an embodiment, a resistivity of the vaporization portion 133 under a condition of 60° C. to 300° C. is 1×10⁻Ω/cm to 1×10² Ω/cm. Further, the resistivity of the vaporization portion 133 under the normal temperature condition is 1×10¹ Ω/cm to 1×10⁵ Ω/cm; and/or, the resistivity of the vaporization portion 133 under the condition of 60° C. to 300° C. is 1×10⁻¹ Ω/cm to 1×10¹⁵ Ω/cm.

In an embodiment, the material of the vaporization portion 133 is a normal temperature NTC thermistor ceramic. Further, the vaporization portion 133 is doped with at least one of La, Nd, or Ce. Doping at least one of La, Nd, or Ce reduces a thermosensitive constant and the resistivity under the normal temperature condition. In an embodiment, the vaporization portion 133 is doped with La. Further, the doping amount of La is 0.2%.

Certainly, the vaporization portion 133 is also provided with an end electrode, and the end electrode of the vaporization portion 133 is electrically connected to the power supply. The end electrode of the vaporization portion 133 also forms an ohmic contact with the preheating portion 131. The formation of ohmic contact between a metal and a semiconductor means that a pure resistor is located at the contact position, and the resistor is as small as possible, so that when a component operates, most of voltage drop is in an active region and not on a contact surface. Therefore, an I-V feature of the ohmic contact is a linear relationship. The larger the slope, the smaller the contact resistance. The magnitude of the contact resistance directly affects performance index of a device. The ohmic contact is widely applied to metal processing, and mainly achieves high doping in a semiconductor surface layer or introduce a large amount of recombination centers.

It may be understood that, the shape of the vaporization portion 133 is not particularly limited, and may adopt a common shape in the art. For example, the shape may be a sheet shape, a grid shape, or a bar shape.

Specifically, the seal member 140 is located between the heating assembly 130 and the liquid storage container 110, and is configured to seal a gap between the heating assembly 130 and the liquid storage container 110, so that the liquid to be vaporized can reach the vaporization portion 133 to be vaporized without flowing out from a liquid guide portion and/or a side wall of the preheating portion 131.

The connection circuit is configured to electrically connect the preheating portion 131 and the vaporization portion 133 to the power supply. The preheating portion 131 and the vaporization portion 133 are connected to the power supply after being connected in parallel through the connection circuit. It may be understood that in some other embodiments, the connection circuit may be omitted. When the connection circuit is omitted, the vaporizer 100 during use causes, through the connection circuit provided outside, the power supply to supply power to the preheating portion 131 and the vaporization portion 133 that are connected in parallel.

The power supply is configured to supply power to the vaporizer 100. Further, the power supply is configured to supply power to the heating assembly 130. In this implementation, the power supply is accommodated in the shell 101. Certainly, in other implementations, the power supply may not be accommodated in the shell 101. In this case, the power supply may be separately accommodated in a housing, or the power supply may be accommodated in a space formed by extending of the liquid storage container 110 in an extension direction of the liquid storage container. It may be understood that in some other implementations, the power supply may be omitted. When the power supply is omitted, the vaporizer 100 supplies power to the heating assembly 130 through an external power supply.

The electronic vaporizer 10 has the following advantages.

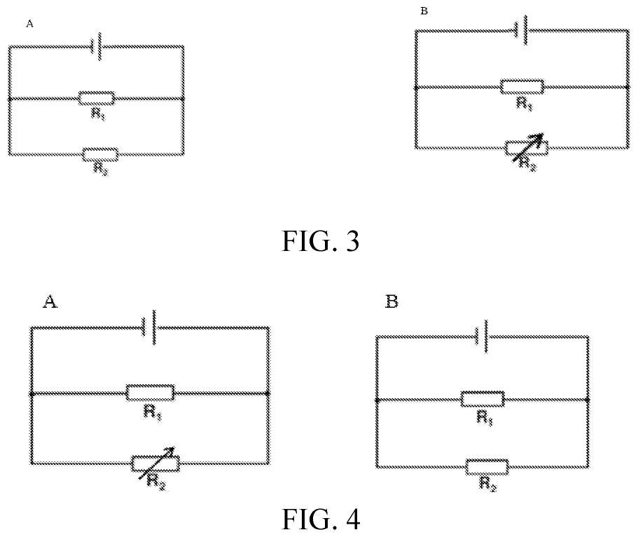

(1) The preheating portion 131 is made of a porous ceramic, and the preheating portion 131 is made of a positive temperature coefficient thermosensitive material, so that the preheating portion 131 has a property of a thermistor while having a liquid guide function. Referring to FIG. 3 (A in FIG. 3 is a circuit diagram at an initial stage of electrification, B in FIG. 3 is a circuit diagram at a later stage of electrification, R1 is the vaporization portion 133, and R2 is the preheating portion 131), at the initial stage of electrification, the resistance of the vaporization portion 133 is relatively small, and the current flows through the preheating portion 131 to cause the preheating portion 131 to generate heat to preheat the liquid to be vaporized. As the temperature of the preheating portion 131 gradually increases, the resistance gradually increases, and the flowability of the liquid to be vaporized is improved, so that there is sufficient liquid to be vaporized for the vaporization portion 133 to atomize. When the temperature reaches the Curie temperature, the resistance of the preheating portion 131 rises sharply, so that the circuit in which the preheating portion 131 is located is in an open-circuit state, and the electrical energy is mainly used for vaporization. Therefore, the electronic vaporization device 10 is not prone to the problem of less vapor caused by the insufficient supply due to the relatively high viscosity of the liquid to be vaporized.

(2) The preheating portion 131 does not necessarily always have current flowing. The preheating portion 131 may further preheat the liquid to be vaporized through the residual temperature. When the temperature of the preheating portion 131 is relatively low, the preheating portion can automatically restart the circuit in which the preheating portion 131 is located to cause the preheating portion 131 to generate heat. This working mode can reduce energy consumption of the electronic vaporization device 10.

(3) When the vaporization portion 133 is made of an NTC ceramic, a resistance of the NTC ceramic decreases as the temperature increases. Referring to FIG. 4 (A in FIG. 4 is a circuit diagram at an initial stage of electrification, B in FIG. 4 is a circuit diagram at a later stage of electrification, R1 is the preheating portion 131, and R2 is the vaporization portion 133), at the initial stage of electrification, the resistance of the vaporization portion 133 is relatively large, and the enabling of the vaporization function of the vaporization portion is relatively delayed, so that the electric energy is mainly concentrated on the preheating portion 131. As the preheating portion 131 generates heat continuously, the liquid to be vaporized is preheated, and, part of the heat is also transferred to the vaporization portion 133 so that the resistance of the vaporization portion 133 is reduced, thereby enabling the vaporization function of the vaporization portion 133. Therefore, when the material of the vaporization portion 133 is the NTC ceramic, the heating assembly 130 can perform preheating and vaporization more quickly.

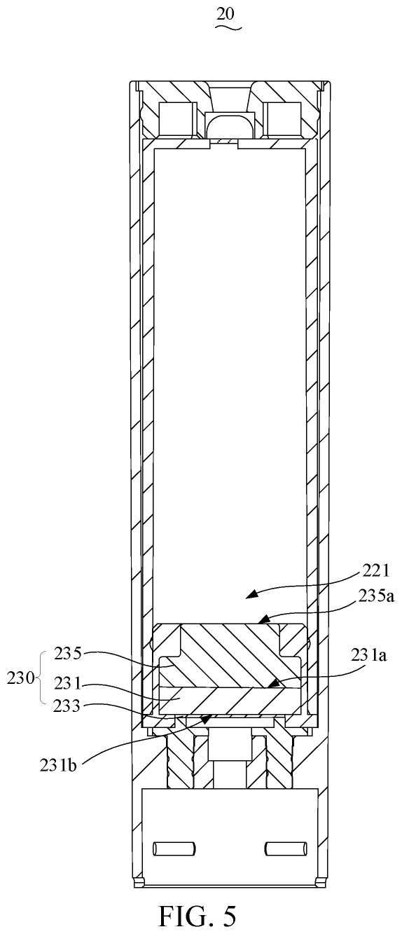

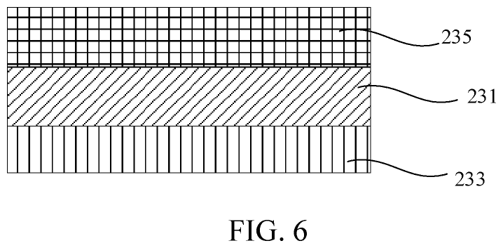

Referring to FIG. 5 and FIG. 6, an electronic vaporization device 20 according to another embodiment is shown. A structure of the electronic vaporization device 20 is basically the same as that of the electronic vaporization device 10. A difference is that a heating assembly 230 of the electronic vaporization device 20 further includes a liquid guide portion 235. The liquid guide portion 235 is located on a side of a preheating portion 231 away from a vaporization portion 233, and the liquid guide portion 235 is made of a porous ceramic. Specifically, the liquid guide portion 235 is located between a liquid outlet 221 and a preheating portion 231, so that liquid to be vaporized reaches the preheating portion 231 through the liquid guide portion 235 after flowing out from the liquid outlet 221. More specifically, the liquid guide portion 235 is located on a liquid inlet surface 231a of the preheating portion 231. The liquid guide portion 235 includes a liquid absorbing surface 235a, and the liquid absorbing surface 235a is far away from the liquid inlet surface 231a.

The electronic vaporization device 20 has a structure similar to that of the electronic vaporization device 10, and therefore, also has advantages similar to those of the electronic vaporization device 10. In addition, the electronic vaporization device 20 is provided with the liquid guide portion 235, so that heat generated by the preheating portion 231 mainly heats the liquid to be vaporized in pores of the preheating portion 231, thereby reducing dissipation of the heat generated by the preheating portion 231 and improving preheating efficiency of the preheating portion 231. On the other hand, the vaporizer has a certain requirement on a thickness of an element that provides a liquid guide function, and both the liquid guide portion 235 and the preheating portion 231 have the liquid guide function. Therefore, the provision of the liquid guide portion 235 is also cost-saving.

The technical features in the foregoing embodiments may be randomly combined. For concise description, not all possible combinations of the technical features in the embodiments are described. However, provided that combinations of the technical features do not conflict with each other, the combinations of the technical features are considered as falling within the scope described in this specification.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating assembly, comprising:
a preheating portion; and
a vaporization portion located on the preheating portion,
wherein the preheating portion comprises a porous ceramic and a positive temperature coefficient thermosensitive material, and
wherein a circuit in which the preheating portion is located is connected in parallel with a circuit in which the vaporization portion is located.

2. The heating assembly of claim 1, wherein under a normal temperature condition, a ratio of a resistance of the vaporization portion to a resistance of the preheating portion is 1:0.1 to 2.

3. The heating assembly of claim 1, wherein a Curie temperature of the preheating portion does not exceed 200° C., and/or
wherein a resistivity of the preheating portion under a normal temperature condition is 0.25 Ω/cm to 28 Ω/cm, and/or
wherein a lift-to-drag ratio of the preheating portion is 1×10² to 1×10⁵.

4. The heating assembly of claim 1, wherein a Curie temperature of the preheating portion is 100° C. to 200° C., and/or
wherein a resistivity of the preheating portion under a normal temperature condition is 1 Ω/cm to 20 Ω/cm, and/or
wherein a lift-to-drag ratio of the preheating portion is 1×10³ to 1×10⁵.

5. The heating assembly of claim 1, wherein the preheating portion comprises a BaTiO₃-based PTC ceramic with a porous structure, a SrTiO₃-based PTC ceramic with a porous structure, a PbTiO₃-based PTC ceramic with a porous structure, or a V₂O₃-based PTC ceramic with a porous structure.

6. The heating assembly of claim 4, wherein the preheating portion is doped with at least one of La, Y, Nb, or Sb.

7. The heating assembly of claim 1, wherein the preheating portion comprises a liquid inlet surface and a liquid outlet surface opposite to the liquid inlet surface, and
wherein the vaporization portion is located on the liquid outlet surface.

8. The heating assembly of claim 1, wherein a material of the vaporization portion comprises at least one of a single metal, an alloy, an NTC ceramic, a carbon fiber, or graphite.

9. The heating assembly of claim 8, wherein the material of the vaporization portion comprises NTC ceramic,
wherein a resistivity of the vaporization portion under the normal temperature condition is 1×10¹ Ω/cm to 1×10⁶ Ω/cm, and/or a resistivity of the vaporization portion under a condition of 60° C. to 300° C. is 1×10⁻¹ Ω/cm to 1×10² Ω/cm.

10. The heating assembly of claim 9, wherein the vaporization portion is doped with at least one of La, Nd, or Ce.

11. The heating assembly of claim 1, further comprising:
a liquid guide portion located on a side of the preheating portion away from the vaporization portion,
wherein the liquid guide portion comprises a porous ceramic.

12. A vaporizer, comprising:
a liquid storage container comprising a liquid storage cavity configured to store a vaporizable liquid, the liquid storage cavity having a liquid outlet; and
the heating assembly of claim 1, the heating assembly being configured to vaporize the vaporizable liquid,
wherein the preheating portion is close to the liquid outlet.

13. The vaporizer of claim 12, wherein the preheating portion is located between the vaporization portion and the liquid outlet, and
wherein the vaporization portion is configured to vaporize the vaporizable liquid that is guided by the preheating portion.

14. An electronic vaporization device, comprising:
a vaporizer, comprising:
a liquid storage container comprising a liquid storage cavity configured to store a vaporizable liquid, the liquid storage cavity having a liquid outlet;
the heating assembly of claim 1, the heating assembly being configured to vaporize the vaporizable liquid, the preheating portion being close to the liquid outlet; and
a power supply configured to supply power to the vaporizer.
